(19) United States
(12) Patent Application Publication
(10) Pub. No.: US 2025/0302014 A1
(43) Pub. Date: Oct. 2, 2025

(54) WASP PEST MANAGEMENT SYSTEM

(71) Applicant: Daradh Toner, Carlow (IE)

(72) Inventor: Daradh Toner, Carlow (IE)

(21) Appl. No.: 18/863,584

(22) PCT Filed: May 8, 2023
(86) PCT No.: PCT/EP2023/062152

§ 371 Date: Nov. 6, 2024

(30) Foreign Application Priority Data
May 6, 2022 (IE) S2022/0078

(51) Int. Cl. A01K 53/00; A01M 29/12; A23K 10/30; A23K 20/163; A23K 50/90

(52) U.S. Cl. CPC A01K 53/00; A01M 29/12; A23K 10/30; A23K 20/163; A23K 50/90

(57) ABSTRACT

A non-toxic wasp feed with a honey bee feed in combination with an insect repellant additive which is repellant to insects other than wasps. The insect repellant additive includes a non-toxic, organic and/or synthetic additive. The wasp pest management system also provides a wasp feeding station containing the non-toxic wasp feed of the invention to control foraging wasps without harming the wasps. A wasp feeding station includes an upstanding weather-proof housing with a ground-engaging base plate at a bottom end of the housing. Wasp access ports are provided at a top of the housing in an elevated position, typically 4 to 5 meters above the base plate. A reservoir containing non-toxic wasp feed of the invention is mounted within the housing together with an associated storage tank for the non-toxic wasp feed.

### INTRODUCTION

This invention relates to a non-lethal wasp pest management system which uses one or more wasp feeding stations to control foraging wasp pests without harming the wasps. The invention also relates to a non-toxic wasp feed for use in such a wasp pest management system.

### BACKGROUND TO THE INVENTION

Wasp pest infestation is a global problem affecting the commercial, public and agricultural sectors. It can result in brand damage and revenue loss through negative perceptions, potential insurance claims and crop damage. Wasps' natural food supply depletes in late summer and facing starvation, they seek alternatives such as the foods, beverages and sugars people enjoy in gatherings and this creates conflict with humans. Conventional solutions such as wasp extermination traps prove ineffective and unpleasant. Traps convey a poor message and have been shown to actually increase the incidence of stings.

Since the onset of condensed farming practices of fruits in vineyards, orchards and fruit farms and the invention of the refinement and processing of sugars to produce sweet foods, soft and alcoholic beverages, mankind has been inadvertently feeding wasps as they have adapted and fed from these human produced food sources to prevent starvation in late summer. The wasp feeding phenomenon is a direct consequence of human food production and this has resulted in wasps becoming regarded as pests.

Unlike honey bees, butterflies, hoverflies and other such pollinators, wasps are not fussy eaters once they begin to starve, and during wasp pest season they will scavenge from any available food source. Starving wasps seeking food are undeterred by traps or the presence of humans. They are attracted by the presence of highly processed foods produced with synthetic sweeteners, flavorings, colorings, aromas, preservatives and additives such as the foods and beverages available in theme parks, sweetshops, bakeries, cafes, bars and at refuse points where food waste, wrappings and containers are discarded.

Unlike honey bees, butterflies, hoverflies and other such pollinator insects, hungry wasp pests are also attracted to aromatic fragrant substances used in perfumes, hair products, colognes, deodorants, cosmetics, vape pens as well as the odors from sugars and syrups contained in soft and alcoholic beverages. Although wasps are recognized as beneficial insects in vineyards, orchards and fruit farms, once starvation begins, they will infest and feast upon ripe fruits causing damage and disease and increasing sting probability for staff and visitors.

It is known to provide traps to lure more wasps into an area often increasing the hazard potential. Trapped, distressed and dying wasps release a pheromone alerting other wasps to become defensive and aggressive and more likely to attack or sting. These traps also indiscriminately kill queen wasps, fertile males, female workers and many other beneficial insect species.

Existing wasp pest control devices offer food sources which are are used for luring or baiting purposes to enable the extermination of wasps by, poisoning, drowning, gluing, trapping, de-hydrating etc.

Generally, housings are configured to trap and kill wasps. Otherwise, devices utilizing housings or enclosures that do not exterminate or trap at point, provide wasps with a protein based toxic food that is then returned to hive and fed to the young larva to poison the entire colony. This last method is employed mainly where the species is considered invasive.

The use of sprays, poisons and insecticides to kill wasps have unfortunate environmental repercussions. These chemicals are highly toxic and cause long-term damage to soil and pollute ground water. As a consequence of cross contamination and bio amplification these toxins cause harm to many other wildlife species, while also tainting the food supply and causing a range of potential health issues for humans. Many of these chemical insecticides are now being restricted or banned.

Social wasps are highly evolved insects and display an advanced level of social organisation-eusocial. Wasps are an integral link of the food web and play a vital role maintaining harmony in our ecosystems. A healthy native wasp population can be noted as a ‘good barometer’ as to the overall health of local biodiversity.

As apex predators, wasps are an essential insect in world food production. They spend the most part of their life cycle as natural bio control agents hunting lepidopteran pests that would otherwise destroy entire food crops. One estimate from the UK states that wasps are responsible for removing 14,000 tonnes of unwanted pests from fruit, crops and gardens annually.

While foraging for insects or nectar wasps are active pollinators collecting pollen on their almost invisible hairs inadvertently transferring it from flower to flower. Hibernating queen wasps store essential yeasts in their gut overwinter, specifically yeasts of the species, Saccharomyces cerevisiae. Keeping these alive in her body as she sleeps through winter, the following season she passes these yeasts on to her colony who go out and disperse them amongst the crops that produce wine, beer and bread. Wasps are also a food source for many other creatures such as birds, spiders, dragonflies, reptiles, frogs, toads and a variety of small mammals which all feed on wasps as part of their diet.

A small number of non-stinging male drone wasps are born at seasons end for reproductive purposes, otherwise all adult wasps are female, have a proboscis and cannot consume solid foods. These adult wasps spend their lives hunting protein rich insect's and insect larvae which they then return to the hive and feed in a masticated form to the young wasp larvae who in return secrete a nutritional syrup from glands that the adults then consume, a food exchange process known as trophallaxis. Aside from nectar and sap this hive larvae produced syrup is the adult wasps primary food source.

This food exchange process begins to naturally decline in late summer as the hive queen begins to lay ever decreasing quantities of eggs, resulting in increasing populations of adult wasps with no larvae to feed and therefore no liquid food to consume.

With an ever depleting food supply and facing starvation wasps have little choice but resort to seeking out alternative food sources and so commences the annual wasp pest season when wasps swarm and infest public and private areas, businesses, industries and ripened fruits seeking nourishment. This annual natural phenomenon causing the dietary shift of wasps from beneficial insect predator to food scavenger has unfortunately earned the wasp its pest reputation amongst society.

An objective of the wasp pest management system of this invention is to produce wasp pest free environments. Accomplishing this objective will result in benefit to businesses, organisations, agriculture and society and achieving this without causing harm to the ecosystem will have a positive impact on biodiversity and the environment.

### SUMMARY OF THE INVENTION

According to the invention, there is provided a non-toxic wasp feed comprising a honey bee feed in combination with at least one organic and/or synthetic additive that provides the wasp feed with repellent properties and effects to honey bees and insects other than wasps.

In one embodiment of the invention, the additive comprises a substance which is generally recognised as safe. Generally recognised as safe (GRAS) refers to an ingredient considered safe for addition to food by the US Food and Drug Administration.

In another embodiment, the at least one organic and synthetic additive includes one or more of the substances listed in Table 1 herein.

In another embodiment, the honey bee feed is produced by dissolving sucrose in water in quantities up to 2200 g of sucrose per 1000 ml of water.

In another embodiment, the honey bee feed is high fructose corn syrup or a feed normally consumed by honey bees.

In another embodiment, the wasp feed comprises a honey bee feed in an amount in the range 10%-90% by volume or weight and the at least one organic and/or synthetic additive in an amount in the range 90%-10% by volume or weight.

In another embodiment, there is provided a wasp feed for non-lethal control of wasp pest populations commonly referred to as Yellow-Jackets, within the Order: Hymenoptera, Family: Vespidae, Genus: Vespula, such as; Common, Eastern, Western, Northern, Southern and Aerial Yellow Jackets, Vespula Germanica, Vespula Vulgaris, Vespula Pensylvanica, Vespula Squamosa, Vespula Maculiforna, Paper wasps and other such pest insects.

In another embodiment, the wasp feed comprises a blend of traditional honey bee feed syrup with sufficient quantities of the at least one organic and/or synthetic additive that is repugnant and repellent to honey bees, and other non-target pollinators such that the wasp feed is inedible and non-attractive to honey bees and avoided for consumption by butterflies, hoverflies and other non-target pollinators.

In another embodiment, the wasp feed comprises a wasp feed formulation of liquid, solid, semisolid, powder or jelly which contains a higher sugar, sucrose or fructose content than foods either produced, consumed or discarded by humans, including agricultural food sources such as the fruits of vineyards, orchards and fruit farms.

In another embodiment, the wasp feed comprises a blend of traditional honey bee feed syrup with sufficient quantities of the at least one organic and/or synthetic additive which is generally recognized as safe for use in the food, beverage, cosmetic, wellness, pharmaceutical and other such industries, such as food additives, flavorings, aromas, sweeteners, syrups, enhancers, preservatives, alcohols, aldehydes, ketones, esters, lactones, pyrazines, thiols, essential oils, hydrosols, phenols, natural extracts & isolates.

In another embodiment, there is provided an effective non-trap-non-kill-non-toxic system of wasp pest control by continuously feeding wasps with the wasp feed as claimed in any one of the preceding claims to divert wasp pest activity away from humans, foods, beverages, fruit crops, refuse points, buildings, structures and other areas prone to wasp pest infestation without causing harm or stress to the wasp.

In another embodiment, the system includes a weatherproof wasp feeding station, comprising an upstanding column housing to achieve elevation, wasp access ports to a top section of the housing allowing wasps access to and from a wasp feed supply within the housing.

In another embodiment, the wasp feeding station includes an internal feeding array of food distribution canals and landing surfaces, the feeding array arranged in a vertical, horizontal, angled or a curved configuration, the wasp feeding station adapted for automated processes of feed delivery, feed sanitation, regulated feed temperature, apparatus for dispersion of feed aroma such as vaporization, atomization or evaporation.

In another embodiment, the system includes a wasp feeding station having a support for a block of solid wasp feed, at least one dispensing element for dispensing a mist of liquid droplets against a surface of the solid feed block to dissolve the surface of the solid feed block into a liquid wasp feed.

In another embodiment, the support comprises a support platform for reception and mounting of the block of solid wasp feed.

In another embodiment, the support is movable vertically.

In another embodiment, a level sensor is provided to sense the location of an upper surface of the block of solid wasp feed and positioning means is provided for maintaining the upper surface of the block of solid wasp feed at a desired location.

In another embodiment, the positioning means comprises one or more levelling elements connected to the support platform for positioning the upper surface of the block of solid feed at the desired location.

In another embodiment, the support is rotatable.

In another embodiment, the support is a turntable.

In another embodiment, the support is a rotatable spindle.

In another embodiment, the wasp feeding station comprises:
a base frame,
a liquid storage tank mounted on the base frame,
a feed reservoir mounted on the base frame for reception and storage of the block of solid wasp feed,
a liquid delivery system for delivering liquid from the liquid storage tank to one or more spray heads for discharge onto the block of solid wasp feed,
a weather protection dome mounted on the base frame above the reservoir to define a feeding compartment within the dome,
at least one access port on the dome to allow through passage of wasps into the feeding compartment to feed at the reservoir.

In another embodiment, a tower is mounted at one side of the base frame to support communications and monitoring equipment.

In another aspect, the invention provides a wasp feeding station, including a support for a block of solid feed, at least one dispensing element for dispensing a mist of liquid droplets against a surface of the block of solid feed to dissolve the surface of the block of solid feed into a liquid wasp feed.

### BRIEF DESCRIPTION OF THE DRAWINGS

The invention will be more clearly understood from the following description of some embodiments thereof, given by way of example only, with reference to the accompanying drawings, in which:

FIG. 1 is a perspective view of a wasp feeding station according to the invention;

FIG. 2 is an exploded perspective view of the wasp feeding station;

FIG. 3 is a detail perspective view showing a base frame and tower portion of the wasp feeding station;

FIG. 4 is a detail exploded perspective view of the base frame and tower portion of the wasp feeding station;

FIG. 5 is a detail perspective view of a solid wasp feed reservoir forming portion of the wasp feeding station;

FIG. 6 is a detail exploded perspective view of the solid wasp feed reservoir;

FIG. 7 is an underneath perspective view of the solid wasp feed reservoir;

FIG. 8 is an enlarged detail perspective view showing portion of the solid wasp feed reservoir and irrigation pipework;

FIG. 9 is an enlarged detail perspective cut-away view showing portion of the solid wasp feed reservoir assembly;

FIG. 10 is a detail perspective view showing a weatherproof enclosure assembly forming portion of the wasp feeding station;

FIG. 11 is an exploded perspective view showing the weatherproof enclosure assembly;

FIG. 12 is a perspective view of a wasp feeding station according to a second embodiment of the invention;

FIG. 13 is a perspective view of the wasp feeding station according to a third embodiment of the invention;

FIG. 14 is a perspective view of another wasp feeding station.

### DETAILED DESCRIPTION OF THE PREFERRED EMBODIMENTS

The wasp management system of the invention provides a wasp feeding station containing a non-toxic wasp feed of the invention to control foraging wasp pests without harming the wasps. A wasp feeding station for use with the wasp pest management system is shown in FIG. 14 and is indicated generally by the reference numeral 100, and comprises an upstanding weather-proof housing 101 with a ground-engaging base plate 102 at a bottom end of the housing 101. Wasp access ports 104 are provided at a top of the housing 101 in an elevated position, typically 4 to 5 meters above the base plate 102. A reservoir containing non-toxic wasp feed of the invention is mounted within the housing 101 together with an associated storage tank for the non-toxic wasp feed. The wasp feeding station is operable to provide a continuous supply of non-toxic wasp feed. Wasps can readily access the non-toxic wasp feed through access ports 104 at the top of the housing 101. Other suitable wasp feeding stations are described later and further suitable wasp feeding stations are described in my earlier patent application—publication no. WO 2021/191472 A1, the contents of which are incorporated herein by reference.

For the last hundred years or so, traditional honey bee feed has been intentionally fed to bees by beekeepers during periods when flower produced nectars are unavailable either early or late season. Quantities of sucrose are dissolved in water to produce honey bee feed syrup, the nutritional content of the syrup is defined by the ratio of sucrose to water, i.e. 1:1, 2:1 kg/l honey bee feed. For increased shelf life a preservative is often added such as thymol or chlorine. This traditional honey bee feed recipe is considered the most nutritionally optimum substitute in the absence of plant produced nectars. To a lesser extent some bee-keepers may also use high fructose corn syrup as a nectar substitute to feed honey bees. The traditional honey bee feed recipe provides the necessary high sugar content syrup for production of the non-toxic wasp feed of the invention.

The next step in development of the non-toxic wasp feed of the invention is to degrade and corrupt the purity of the traditional honey bee feed syrup by adding and blending sufficient quantities of organic and/or synthetic additive substances and compounds that are repugnant and repellent to honey bees and other such non-target pollinator insects.

For this step we utilize organic and/or synthetic additives, substances and compounds generally recognized as safe for use in food, beverage, cosmetic, pharmaceutical, health and wellness and other such industries. A majority of these are actually attractive, considered edible by wasp pests such as food additives, flavorings, preservatives, sweeteners, enhancers, aromatic agents, syrups, alcohols, aldehydes, ketones, esters, lactones, pyrazines, thiols, essential oils, hydrosols, phenols, natural extracts & isolates etc.

These additives when blended in sufficient quantities become infused with the traditional honey bee feed and deteriorate the feed quality to the stage that the resulting non-toxic wasp feed mixture of the invention is repugnant, inedible and not collected by honey bees for honey production and avoided as a food for consumption by butterflies, hoverflies and other such non target pollinator insects.

The production the non-toxic wasp feed of the invention is achieved by blending traditional honey bee feed syrup with adequate quantities of one or more or combinations of the following substances listed in Table 1 below;

### Table 1

Acetanisole, acetaldehyde diethyl acetal, acetaldehyde phenethyl propyl acetal, acetophenone, allyl anthranilate, allyl butyrate, allyl cinnamate, allyl cyclohexaneacetate, allyl cyclohexanebutyrate, allyl cyclohexanehexanoate, allyl cyclohexanevalerate, allyl disulfide, allyl 2-ethylbutyrate, allyl hexanoate, allyl caproate, allyl α-ionone, allyl isothiocyanate, allyl isovalerate, allyl mercaptan, allyl nonanoate, allyl octanoate, allyl phenoxyacetate, allyl phenylacetate, allyl propionate, allyl sorbate, allyl 2,4-hexadienoate, allyl sulfide, allyl tiglate, allyl trans-2-methyl-2-butenoate, allyl 10-undecenoate, ammonium isovalerate, amyl alcohol, amyl butyrate, α-amylcinnamaldehyde, α-amylcinnamaldehyde dimethyl acetal, α-amylcinnamyl acetate, α-amylcinnamyl alcohol, α-amylcinnamyl formate, α-amylcinnamyl isovalerate, amyl formate, amyl heptanoate, amyl hexanoate, amyl octanoate, anisol, anisyl acetate, anisyl alcohol, anisyl butyrate, anisyl formate, anisyl phenylacetate, anisyl propionate, acetic acid, α-pinene, anisole, amyl butyrate, amyl acetate, amyl caproate, amyl valerate, azorubine, ammonia caramel, annatto, advantame, alginic acid, ammonium alginate, agar, acetylated distarch phosphate, acetylated starch, acetylated distarch adipate, acetylated oxidised starch, acesulfame K, aspartame, adipic acid, ammonium carbonate, ammonium sulphate, aluminium potassium sulphate, aluminium ammonium sulphate, ammonium hydroxide, acesulfame potassium, advantame, aspartame, agave syrup, acesulfame potassium, agave nectar, beechwood creosote, benzaldehyde, benzaldehyde dimethyl acetal, benzaldehyde glyceryl acetal, benzaldehyde propylene glycol acetal, benzenethiol, benzoin, benzyl acetate, benzyl acetoacetate, benzyl alcohol, benzyl benzoate, benzyl ethanoate, benzyl butyl ether, benzyl butyrate, benzyl cinnamate, benzyl 2,3-dimethylcrotonate, benzyl methyl tiglate, benzyl disulfide, dibenzyl disulfide, benzyl ethyl ether, benzyl formate, 3-Benzyl-4-heptanone, benzyl isobutyrate, benzyl isovalerate, benzyl mercaptan, benzyl methoxyethyl acetal, benzyl phenylacetate, benzyl propionate, benzyl salicylate, borneol, bornyl acetate, bornyl formate, bornyl isovalerate, bornyl valerate, butanol, i-butanol, 1-butanol, 2-butanol, 2-butanone, butyl acetate, butyl acetoacetate, butyl alcohol, butyl anthranilate, butyl butyrate, butyl butyryllactate, butyl ester, α-butylcinnamaldehyde, butyl cinnamate, butyl 2-decenoate, butyl ethyl malonate, butyl formate, butyl heptanoate, butyl hexanoate, butyl p-hydroxybenzoate, butyl isobutyrate, butyl isovalerate, butyl lactate, butyl laurate, butyl levulinate, butyl phenylacetate, butyl propionate, butyl stearate, butyl sulfide, butyl 10-undecenoate, butyl valerate, butyraldehyde, benzyldimethylcarbinyl butyrate, benzyldimethylcarbinyl formate, benzylpropyl acetate, benzoic acid, β-pinene, benzophenone, bornyl acetate, benzyl butanoate, benzyl propanoate, betanin, benzoic acid, boric acid, basic methacrylate copolymer, beta-cyclodextrin, cadinene, camphene, d-camphor, carvacrol, carvacryl ethyl ether, 2-ethoxy-p-cymene, carveol, 4-carvomenthenol, carvone oxide, carvyl acetate, carvyl propionate, β-caryophyllene, caryophyllene alcohol, caryophyllene alcohol acetate, β-caryophyllene oxide, cedarwood oil alcohols, cedarwood oil terpenes, 1,4-cineole, cinnamaldehyde ethylene glycol acetal, cinnamic acid, cinnamyl acetate, cinnamyl alcohol, cinnamyl benzoate, cinnamyl butyrate, cinnamyl cinnamate, cinnamyl formate, cinnamyl isobutyrate, cinnamyl isovalerate, cinnamyl phenylacetate, cinnamyl propionate, citral diethyl acetal, citral dimethyl acetal, citral propylene glycol acetal, citronella, citronellol, d-citronellol, citronelloxyacetaldehyde, citronellyl acetate, citronellyl butyrate, citronellyl formate, citronellyl isobutyrate, citronellyl phenylacetate, citronellyl propionate, citronellyl valerate, p-cresol, cuminaldehyde, cuminal, cyclohexaneacetic acid, cyclohexaneethyl acetate, cyclohexyl acetate, cyclohexyl anthranilate, cyclohexyl butyrate, cyclohexyl cinnamate, cyclohexyl formate, cyclohexyl isovalerate, cyclohexyl propionate, p-cymene, citric acid, curcumin, caustic sulphite caramel, calcium tartrate, cassia gum, amidated pectin, ammonium phosphatide, cyclamic acid, calcium disodium EDTA, calcium inosinate, candelilla wax, carnauba wax, corn syrup, calcium benzoate, fruit juice concentrates, crystalline fructose, chlorine, γ-decalactone, 4-hydroxy-decanoic acid, δ-lactone, decanal dimethyl acetal, decylic alcohol, 2-decenal, 3-decen-2-one, decyl actate, decyl butyrate, decyl propionate, dibenzyl ether, 4,4-dibutyl-γ-butyrolactone, 4,4-dibutyl-4-hydroxy-butyric acid, diethyl malate, diethyl malonate, diethyl succinate, diethyl tartrate, 2,5-diethyltetrahydrofuran, dihydrocarvone, dihydrocarvyl acetate, m-dimethoxybenzene, p-dimethoxybenzene, dimethyl hydroquinone, 2,6-dimethyl-5-heptenal, 3,7-dimethyl-1-octanol, α-dimethylphenethyl alcohol, dimethyl benzyl carbinol, α,α-dimethylphenethyl butyrate, dimethyl succinate, 1,3-diphenyl-2-propanone, dibenzyl ketone, delta-dodecalactone, deltalactone, γ-dodecalactone, 2-dodecenal, 1-dodecanol, 3,7-dimethyl-6-octenal, disodium guanylate, dipotassium guanylate, disodium inosinate, dipotassium inosinate, diphosphates, distarch phosphate, dimethyl decarbonate, dimethylpolysiloxane, dextrose, estragole, ρ-ethoxybenzaldehyde, ethyl acetoacetate, ethyl 2-acetyl-3-phenylpropionate, ethylbenzyl acetoacetate, ethyl aconitate, ethyl ρ-anisate, ethyl anthranilate, ethyl benzoate, ethyl benzoylacetate, α-ethylbenzyl butyrate, ethyl brassylate, 2-ethylbutyl acetate, 2-ethylbutyraldehyde, 2-ethylbutyric acid, ethyl cinnamate, ethyl crotonate, ethyl cyclohexanepropionate, ethyl decanoate, 4-ethylguaiacol, 4-ethyl-2-methoxyphenol, ethyl heptanoate, 2-ethyl-2-heptenal, ethyl hexanoate, ethyl isobutyrate, ethyl isovalerate, ethyl lactate, ethyl laurate, ethyl levulinate, ethyl maltol, ethyl 2-methylbutyrate, ethyl myristate, ethyl nonanoate, ethyl 2-nonynoate, ethyl octyne carbonate, ethyl octanoate, ethyl phenylacetate, ethyl 3-phenylglycidate, ethyl 3-phenylpropionate, ethyl hydrocinnamate, ethyl propionate, ethyl pyruvate, ethyl salicylate, ethyl sorbate, ethyl sobate, ethyl tiglate, ethyl undecanoate, ethyl 10-undecenoate, ethyl valerate, eucalyptol, cineole, eugenyl acetate, eugenyl formate, ethyl butyrate, ethyl acetate, eucalyptol, ethyl isovalerate, ethyl lauroyl arginate, ethyl cellulose, ethyl heptanoate, ethyl cinnamate, ethyl nonanoate, ethyl lactate, ethyl pelargonate, ethyl phenylacetate, ethyl formate, ethyl caproate, erythrosine, ethyl malonate, ethyl methyl cellulose, ethyl p-hydroxybenzoate, erythritol, evaporated cane juice, essence of cherry, essence of almond, essence of apricot, farnesol, d-fenchone, fenchyl alcohol, formic acid, furyl acetone, fumaric acid, fructose, fruit oils, fruit extracts, geranyl acetoacetate, geranyl acetone, geranyl benzoate, geranyl butyrate, geranyl formate, geranyl hexanoate, geranyl isobutyrate, geranyl isovalerate, geranyl phenylacetate, geranyl propionate, glucose pentaacetate, guaiacol, guaiacyl acetate, guaiene, guaiol acetate, geranyl valerate, geranyl butyrate, geranyl acetate, guar gum, gellan gum, glyceryl diacetate, glyceryl triacetate, gelatin, galactose, glucose, heptanal, heptanal dimethyl acetal, acetyl valeryl, 3-heptanol, 2-heptanone, 3-heptanone, 4-heptanone, heptyl butyrate, heptyl cinnamate, heptyl formate, heptyl isobutyrate, ω-6-hexadecenlactone, 16-hydroxy-6-hexadecenoic acid, γ-Hexalactone, hexanal, 2,3-hexanedione, hexanoic acid, 2-hexenal, 2-hexen-1-ol, 3-hexen-1-ol, 2-hexen-1-yl acetate, 3-hexenyl isovalerate, cis-3-hexenyl phenylacetate, hexyl acetate, hexyl alcohol, hexyl butyrate, α-hexylcinnamaldehyde, hexyl formate, hexyl hexanoate, hexyl isovalerate, hexyl 2-methylbutyrate, hexyl octanoate, hexyl phenylacetate, n-hexyl phenylacetate, hexyl propionate, hydroxycitronellal, hydroxycitronellal diethyl acetal, hydroxycitronellal dimethyl acetal, hydroxycitronellol, trans-2-hexenol, cis-2-hexenol, trans-2-hexenal, 1-hexanol, trans-2-hexanol, 2-heptanone, hexamethylene tetramine, hydroxypropyl methyl cellulose, hydroxy propyl distarch, heptylidene acetone, heliotropyl acetate, α-Ionone, β-Ionone, α-Irone, isoamyl acetate, isoamyl acetoacetate, isoamyl alcohol, isoamyl benzoate, isoamyl butyrate, isoamyl cinnamate, isoamyl formate, isoamyl 2-furanbutyrate, α-isoamyl furfurylpropionate, isoamyl 2-furanpropionate, α-isoamyl furfurylacetate, isoamyl hexanoate, isoamyl isobutyrate, isoamyl isovalerate, isoamyl laurate, isoamyl-2-methylbutyrate, isoamyl nonanoate, isoamyl octanoate, isoamyl phenylacetate, isoamyl propionate, isoborneol, isobornyl acetate, isobornyl formate, isobornyl isovalerate, isobornyl propionate, isobutyl acetate, isobutyl alcohol, isobutyl angelate, isobutyl anthranilate, isobutyl benzoate, isobutyl butyrate, isobutyl cinnamate; isobutyl formate, isobutyl hexanoate, isobutyl isobutyrate, α-isobutylphenethyl alcohol, isobutyl benzyl carbinol, isobutyl phenylacetate, isobutyl propionate, isobutyl salicylate, 2-isobutylthiazole, isoeugenol, isoeugenyl acetate, isoeugenyl benzyl ether, isoeugenyl ethyl ether, ethyl isoeugenol, isoeugenyl formate, isoeugenyl methyl ether, methyl isoeugenol, isoeugenyl phenylacetate, isojasmone, α-Isomethylionone, Isopropyl acetate, isopropanol, isopropyl benzoate, isopropyl butyrate, isopropyl cinnamate, isopropyl formate, isopropyl hexanoate, isopropyl isobutyrate, isopropyl isovalerate, isopropyl phenylacetate, cuminyl acetaldehyde, isopulegol, isopulegone, isovaleric acid, isobutyl acetate, isopentyl acetate, isopentenyl acetate, isoamyl butyrate, indigotine, isomalt, invertase, inosinic acid, cis-Jasmone, lithol rubine BK, linalool oxide, linalyl anthranilate, linalyl benzoate, linalyl butyrate, linalyl cinnamate, linalyl formate, linalyl hexanoate, linalyl isobutyrate, linalyl isovalerate, linalyl octanoate, linalyl propionate, linalool, linalyl format, linalyl acetate, linalyl butyrate, linalyl formate, lauric aldehyde, lauryl acetate, lauryl alcohol, lepidine, lycopene, lactitol, luo han guo, maltol, menthadienol, menthadienyl acetate, p-menth-3-en-1-ol, 1-p-menthen-9-yl acetate, menthol, menthone, menthyl acetate, 4-methylguaiacol, methoxystyryl isopropyl ketone, 2-methoxy-4-vinylphenol, methyl acetate, p-methylacetophenone, methyl anisate, methylbenzyl acetate, α-methylbenzyl acetate, α-methylbenzyl butyrate, α-methylbenzyl isobutyrate, α-methylbenzyl propionate, 2-methylbutyl isovalerate, methyl butyrate, α-methylcinnamaldehyde, methyl cinnamate, methylcyclopentenolone, methyl heptanoate, methyl hexanoate, methylparaben, methyl α-ionone, methyl isobutyrate, methyl isovalerate, methyl-3-methylthiopropionate, methyl laurate, methyl N-methylanthranilate, methyl 2-methylbutyrate, methyl β-naphthyl ketone, methyloctyne carbonate, methyl hexyl acetaldehyde, methyl heptine carbonate, 4-methyl-2,3-pentanedione, 4-methyl-2-pentanone, methyl isobutyl ketone, β-methylphenethyl alcohol, methyl phenylacetate, 2-methyl-4-phenyl-2-butyl acetate, 2-methyl-4-phenyl-2-butyl isobutyrate, 4-methyl-1-phenyl-2-pentanone, methyl hydrocinnamate, methyl propionate, 3-methyl-5-propyl-2-cyclohexen-1-one, 3-methylthiopropionaldehyde, methional, 2-methyl-3-tolylpropionaldehyde, 2-methylundecanal, methyl nonyl acetaldehyde, methyl 9-undecenoate, methyl 2-undecynoate, methyl decyne carbonate, 2-methylvaleric acid, myristaldehyde, methyl butyrate, methylbenzyl acetate, methyl anthranilate, menthyl acetate, methyl butyrate, methyl salicylate, maltitol, metatartaric acid, monopotassium glutamate, monoammonium glutamate, 8-p-menthen-2-ol, methoxybenzene, mono propylene glycol, maltose, methyl p-hydroxybenzoate, malt syrup, maple syrup, molasses, malic acid, d-neomenthol, nerol, nerolidol, neryl acetate, neryl butyrate, neryl formate, neryl isobutyrate, neryl isovalerate, neryl propionate, gamma-nonalactone, 2,6-nonadien-1-ol, γ-nonalactone, nonanal, 1,3-nonanediol acetate, nonanoic acid, 2-nonanone, 3-nonanon-1-yl acetate, nonyl acetate, nootkatone, 1-nonanol, 2-nonanol, nonyl acetate, nonyl caprylate, n-amyl salicylate, nisin, natamycin, neohesperidine DC, neotame, ocimene, trans-β-ocimene, γ-octalactone, octanal, octanal dimethyl acetal, 1-octanol, octyl alcohol, 2-octanol, 3-octanol, 2-octanone, 3-octanone, 3-octanon-1-ol, 1-octen-3-yl acetate, octyl acetate, 3-octyl acetate, octyl butyrate, octyl formate, octyl heptanoate, octyl isobutyrate, octyl isovalerate, octyl octanoate, octyl phenylacetate, octyl propionate, 1-octadecanol, octyl acetate, octyl butyrate, octenyl succinic acid modified gum arabic, pentadecanolide, perillaldehyde, p-mentha-1,8-dien-7-yl acetate, phenethyl acetate, phenethyl alcohol, β-phenylethyl alcohol, phenethyl anthranilate, phenethyl butyrate, phenethyl cinnamate, phenethyl formate, phenethyl isobutyrate, phenethyl isovalerate, phenethyl 2-methylbutyrate, phenethyl phenylacetate, phenethyl propionate, phenethyl salicylate, phenethyl senecioate, phenethyl 3,3-dimethylacrylate, phenethyl tiglate, phenoxyacetic acid, 2-phenoxyethyl isobutyrate, phenylacetaldehyde, phenylacetaldehyde 2,3-butylene glycol acetal, phenylacetaldehyde dimethyl acetal, phenylacetaldehyde glyceryl acetal, phenylacetic acid, phenylethyl methyl carbinol, 4-phenyl-3-buten-2-ol, 4-phenyl-3-buten-2-one, 4-phenyl-2-butyl acetate, phenylethyl methyl carbinyl acetate, 1-phenyl-3-methyl-3-pentanol, phenylethyl methyl ethyl carbinol, phenylethyl carbinol, hydrocinnamyl alcohol, 2-phenylpropionaldehyde, 3-phenylpropionaldehyde, 3-phenylpropionic acid, 3-phenylpropyl acetate, 2-phenylpropyl butyrate, 3-phenylpropyl cinnamate, 3-phenylpropyl formate, 3-phenylpropyl hexanoate, 2-phenylpropyl isobutyrate, 3-phenylpropyl isobutyrate, 3-phenylpropyl isovalerate, α-pinene, 2-pinene, β-pinene, pine tar oil, pinocarveol, piperidine, piperitone, piperitenone, piperonyl acetate, polyoxyethylene (20) sorbitan monolaurate, polysorbate 60, polyoxyethylene (20) sorbitan monostereate, polysorbate 80, potassium acetate, propenylguaethol, propionaldehyde, propyl acetate, propyl alcohol, propyl benzoate, propyl butyrate, propyl cinnamate, propyl formate, propyl 2-furanacrylate, propyl heptanoate, propyl hexanoate, propylparaben, propyl isobutyrate, propyl phenylacetate, propyl propionate, pyroligneous acid extract, pyruvic acid, propylene glycol, propionaldehyde, potassium sorbate, potassium benzoate, potassium metabisulphite, potassium hydrogen sulphite, polyglycitol syrup, pectin, polyglycerol polyricinoleate, potassium acetate, potassium citrates, potassium tartrates, phosphoric acid, potassium phosphates, potassium malate, potassium adipate, potassium carbonate, potassium sulphate, polydextrose, pullulan, polyethylene glycol, potassium bromate, polysorbate 80,20,40,60,65, potassium nitrite, propionic acid, potassium propionate, plain caramel, quinoline yellow, quillaia extract, glucose, rhodinol, rhodinyl acetate, rhodinyl butyrate, rhodinyl formate, rhodinyl isobutyrate, rhodinyl isovalerate, rhodinyl phenylacetate, rhodinyl propionate, rum ether, salicylaldehyde, santalol, santalyl acetate, santalyl phenylacetate, monostearate, sucrose octaacetate, styralyl acetate, sorbic acid, sodium benzoate, sodium ethyl p-hydybenzoate, sodium methyl p-hydroxybenzoate, sodium sulphite, sodium metabisulphite, sodium nitrite, sodium propionate, sodium tetraborate, sorbitol, saccharin, steviol glycoside, salt of aspartame-acesulfame, sucrose acetate isobutyrate, sucroglycerides, stearyl tartrate, sorbitan monostearate, sorbitan tristearate, sorbitan monolaurate, sorbitan monooleate, sorbitan monopalmitate, sodium acetate, sodium lactate, sodium citrates, sodium carbonate, sodium sulphate, sodium ferrocyanide, silicon dioxide, sodium gluconate, starch aluminium octenyl succinate, sodium phosphates, sodium malate, sodium adipate, sodium tartrates, stevia leaf extract, syrups, sulphite ammonia caramel, shellac, sucralose, salicylaldehyde, sucrose, α-terpinene, γ-terpinene, α-terpineol, β-terpineol, terpinolene, terpinyl acetate, terpinyl anthranilate, terpinyl butyrate, terpinyl cinnamate, terpinyl formate, terpinyl isobutyrate, 4-terpinenol, terpinyl isovalerate, terpinyl propionate, tetrahydrofurfuryl acetate, tetrahydrofurfuryl alcohol, tetrahydrofurfuryl propionate, tetrahydrolinalool, tolualdehydes, p-tolylacetaldehyde, p-tolyl acetate, 2-tridecenal, triethyl citrate, terpinen-4-ol, terpinyl butyrate, trans-methyl cinnamate, tartrazine, thaumatin, tragacanth, tara gum, tartaric acid, triphosphates, thiophenol, titanium dioxide, γ-undecalactone, undecanal, 2-undecanone, 9-undecenal, undecenoic aldehyde, undecen-1-ol, undecylenic alcohol, valeraldehyde, veratraldehyde, valeric acid, vanillin acetate, verbenol, verbenone, xylitol, xanthan gum, etc.

The non-toxic wasp feed of the invention is non-toxic and continuously sanitized and temperature controlled at the wasp feeding station. What could be defined as occasional consumption by a non-target insect is tolerated as this occurrence will cause no harm to the insect or interfere with the primary function of wasp pest control.

The non-toxic wasp feed of the invention is initially blended as liquid and can be further processed in solid, semisolid, powder or jelly forms, as required.

### EXAMPLES

### Field Test 1.

Traditional honey bee feed utilized as a food source to control the location of pest populations of Vespula Germanica and Vespula Vulgaris by feeding.

At base of Mount Leinster, Ireland, at a rural domestic setting situated over several acres with dwellings and outbuildings, a severe wasp pest infestation was brought under control by providing an external source of traditional honey bee feed syrup, provided from an isolated location away from human interaction. Over a period of several days wasp pests no longer sought or foraged for food sources in any other areas of human habitation and fed exclusively from the provided source of traditional honey bee feed.

The population of feeding wasps increased, the feeding zone was increased and additional feeding trays were added. The quantity of wasps attending and feeding from the honey bee feed was at its peak approximately several thousand within a five minute time frame. The feeding trays were manually refilled daily. Dwellings, out buildings and surrounding areas where completely and permanently clear of wasp pests throughout the feeding process.

To test the ability of traditional honey bee feed to exclusively control the location of the wasp pest activity to within the feeding zone area, other normally wasp pest attractant foods where provided within various proximities of the feeding zone, such as sweet cakes, ice creams, soft and alcoholic beverages. Over several weeks of observations, refreshing, and re-positioning of the normally wasp pest attractant foods, these alternatives were completely discarded by wasps in favor of consuming the traditional bee feed.

During the feeding process there was a necessity to move the feeding zone. A new location 150 metres away from the original site was selected and the feeding trays were carefully repositioned and re-filled. Over a period of several days and after the wasp pests had consumed any food spillages at the original location the entire population of wasp pests relocated and permanently fed at the new location.

As winter was approaching and the weather was starting to get cool, it was observed that quantities of honey bees and butterflies were also feeding from the feed. To address this problem the non-toxic wasp feed of the invention was developed to be undesirable and unattractive for non-target species such as honey bees and butterflies.

### Field Test 2.

Use of the non-toxic wasp feed of the invention for control by feeding of pest populations of Vespula Germanica, Vespula Vulgaris.

A commercial operational theme park was chosen for this test. Two automated wasp feeding stations were fabricated and installed within service areas at opposite ends of the park. The feeding stations had a height of 5 meters. The wasp feeding stations automated processes controlled feed delivery as required, with continuous feed sanitation and regulated feed temperature in an environmentally isolated feed supply tank with agitator and swift airborne dispersion of feed aroma by an atomizer.

Prior to commencement of the test a wasp pest infestation event was already in occurrence in the grounds of the theme park and the premises provided an ideal test site as many sweet foods were purchased, consumed and discarded by patrons on a daily basis. Data on wasp sting events from first aid stations were collected, and observations at food vendors, outside dining areas and refuse points confirmed a high wasp pest infestation was present.

For convenience, two commercial artificial flavoring products were chosen, almond and cherry essence as additives in preparation of the non-toxic wasp feed of the invention. These products contained appropriate quantities of benzaldehyde, linalool, eugenol and mono propylene glycol for test purposes. 2:1 traditional honey bee food syrup was prepared and then further blended with the liquid flavorings that produced a final composite blend of 65% traditional bee food 35% artificial flavoring additives by weight or volume. The solution was then further diluted with water to achieve an ideal viscosity for use in the automated feeding system.

A smaller batch of pure 1:1 traditional honey bee feed syrup was first inputted into the feeding machines and the system was activated. Over a period of one week, it was confirmed that both wasp pests and non-target honey bees were regularly feeding from the traditional honey bee feed in adequate quantities which was ideal for the next step of the test. Overnight the feeding machines were drained, rinsed and sanitized and refilled with the non-toxic wasp feed of the invention, prepared as indicated above.

Over a 72-hour period after the introduction of the non-toxic wasp feed of the invention the quantity of non-target honey bees reduced dramatically, while the populations of wasp pests feeding from the system steadily increased. This trend continued until only an occasional non-target honey bee was observed at the system. Further system adjustments resulted in no non-target honey bees being observed visiting or feeding from the system for the remaining duration of the trial. From the point of introduction of the non-toxic wasp feed of the invention, the feeding system fed wasp pest populations removing the presence of wasp pests foraging in public areas of the theme park.

Controlled feeding of and a relocation of the majority of wasp pest populations was achieved within one week and sustained for the remainder of the season. The achieved reduction of wasp pest activity in public areas of the park was in the region of 93%, while wasp sting incidents were reduced by 95%.

It will be appreciated that the invention provides a non-toxic wasp feed achieved by blending traditional honey bee feed with one or more additives that are repugnant and repellant to honey bees and other non-target pollinators.

The system of the invention provides an effective non-kill-non-trap-non-toxic wasp pest control system.

Advantageously, the invention provides an effective method to control the location of wasp pest activity by feeding without causing harm or stress to the wasp.

The wasp feeding station 100 is a non-kill-non-trap-non-toxic wasp pest control unit. A weather-proof construction, the housing 101 is a tall free-standing column. Its height ensures that wasp pest traffic is safely maintained above people. Wasp access points, provided by the wasp access ports 104, are situated at all sides at the top section of the housing 101 and allow for bi-directional free flow of wasp pests to and from the internal feed supply. Mounted internally beyond the wasp access ports 104 is a vertical array of feed distribution canals and landing surfaces. As wasp pests consume the wasp feed from the canals, level sensors activate a pump connected to an internal supply tank to refill the canals with wasp feed. The feed storage tank contains an agitator and sanitizer. The feed is UV sanitized and temperature controlled. An atomizer is occasionally operable to disperse feed aroma into the environment to attract wasps.

The system achieves a sustained control of wasp pest populations by dispensing a high sugar content non-toxic wasp feed of the invention. The non-toxic wasp feed of the invention has a higher sugar, sucrose and fructose content than foods either produced, consumed or discarded by humans, including natural foods such as the fruits of vineyards, orchards and fruit farms.

The non-toxic wasp feed of the invention is irresistible, produced sweeter than all other foods and once discovered, wasp pests permanently abandon all habitual pest foraging areas in favor of feeding exclusively from these dedicated feeding stations 100.

As the system is active outside in the environment, the non-toxic wasp feed of the invention is purposely blended with one or more additives that make it repugnant and unattractive for consumption by honey bees, butterflies, hoverflies and other such non-target pollinators.

The wasp feeding station facilitates a continuous and controlled feeding of wasp pests. This process permanently diverts wasp pest activity away from humans, foods, beverages, fruit crops, refuse points, buildings, structures and other areas prone to wasp pest infestation without trapping, exterminating or the use of poisons.

A coordinated network of operational wasp feeding stations 100 creates and sustains wasp pest free areas in commercial, public and agricultural locations of any size, vastly reducing the nuisance of wasp pest activity and minimizing sting probability. The system removes wasp pests from coming into conflict with humans and prevents wasp pest damage in fruit crops without causing harm or stress to the wasp.

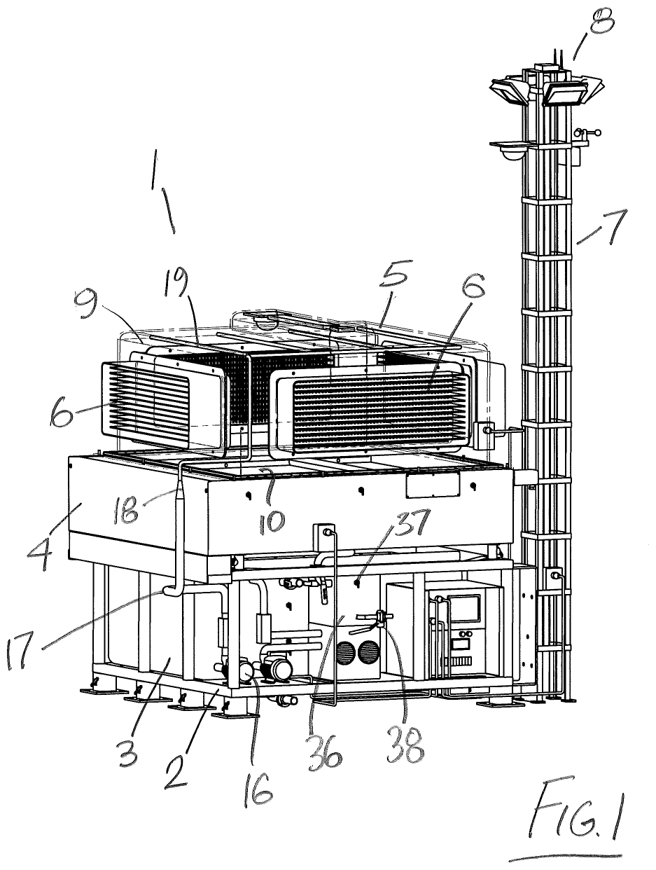

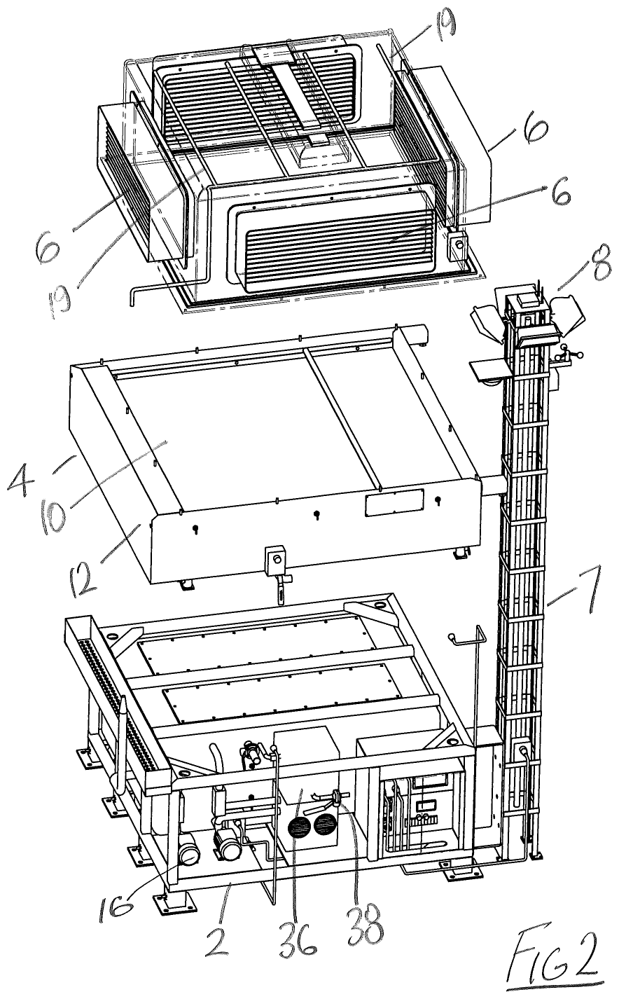

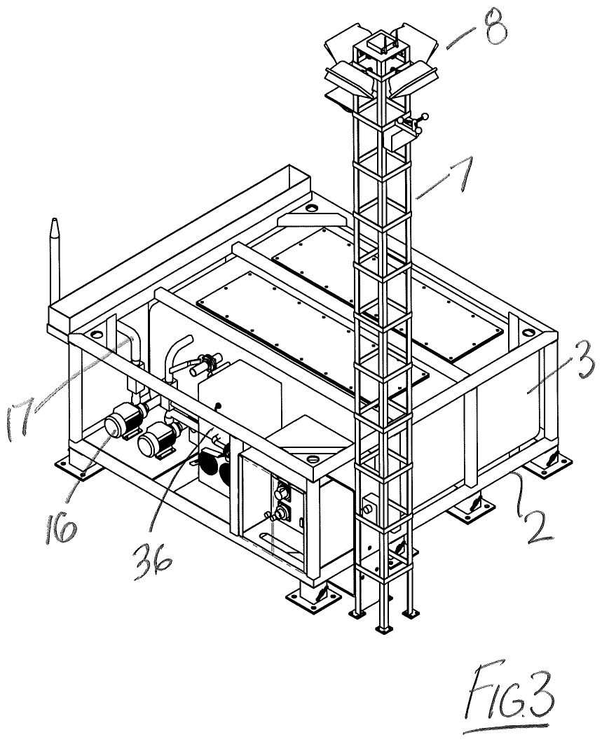

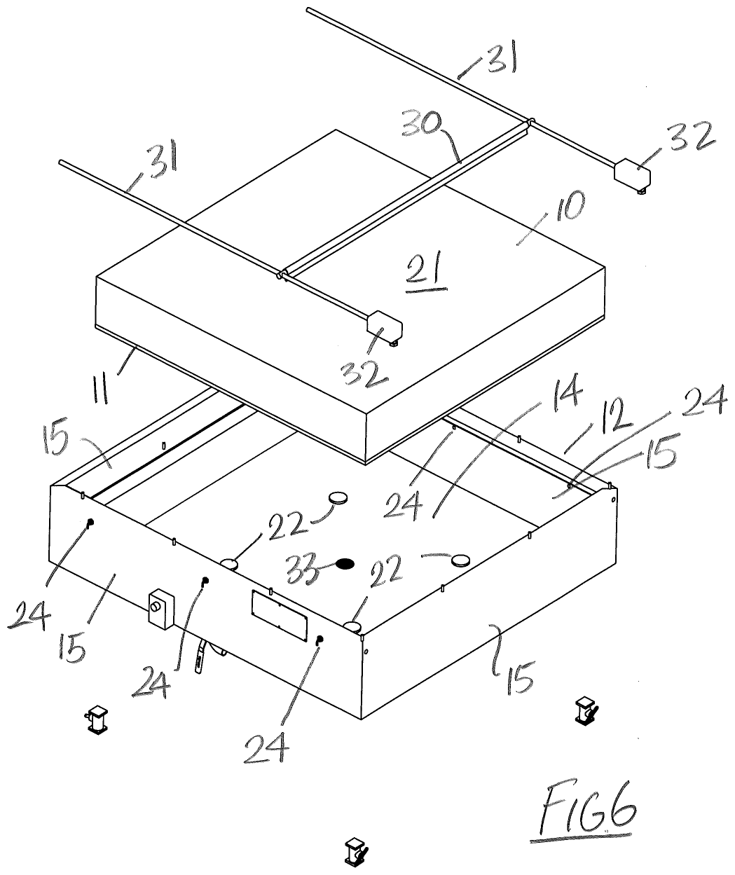

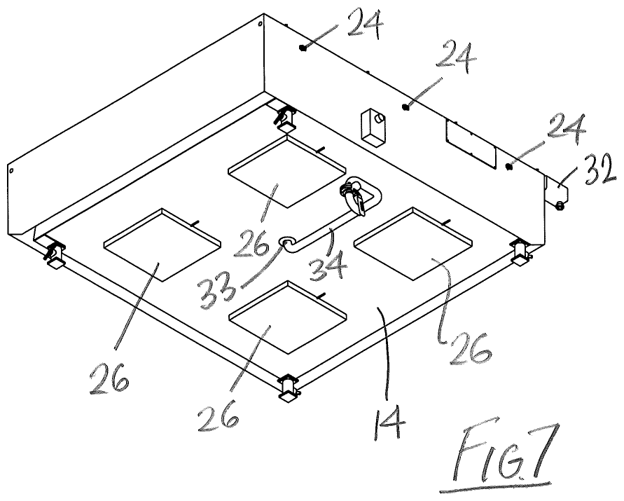

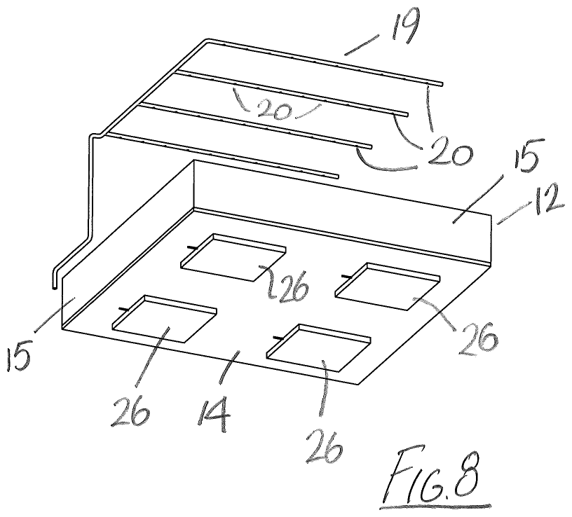

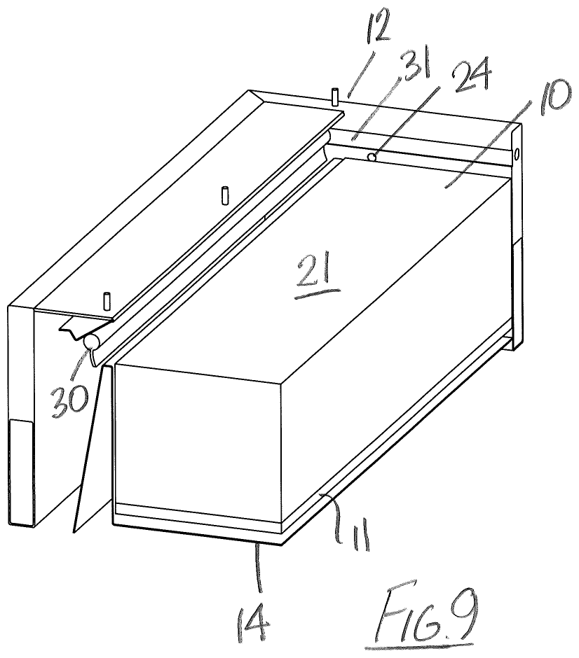

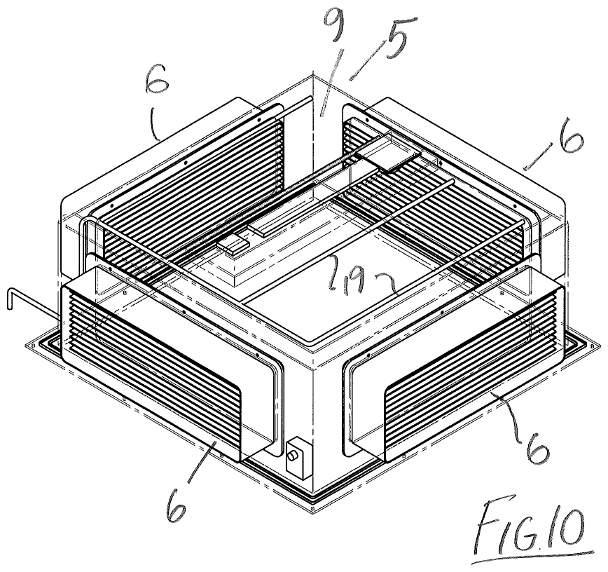

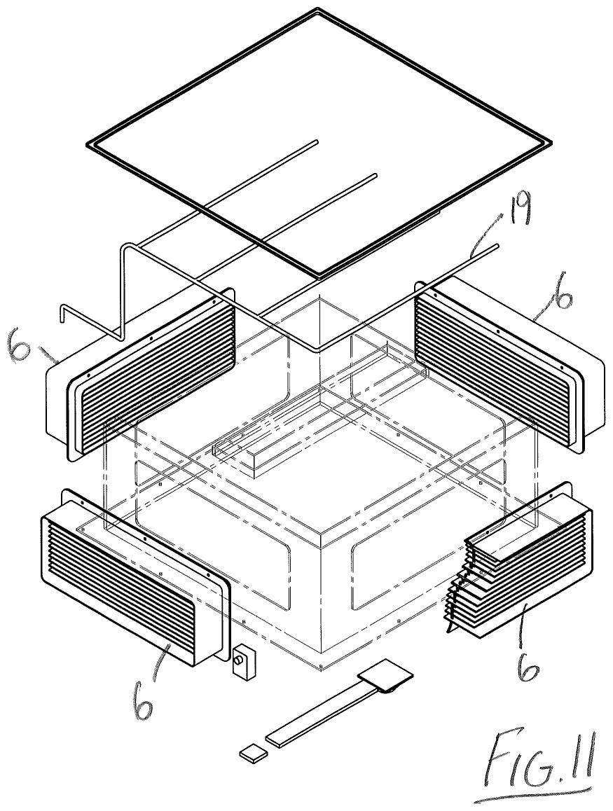

Referring to FIG. 1 to FIG. 11 of the drawings, there is illustrated a wasp feeding station according to the invention, indicated generally by the reference numeral 1. The wasp feeding station 1 has a base frame 2. A liquid storage tank 3 is mounted on the base frame 2. Mounted on top of the base frame 2 is a feed reservoir 4. A weather protection dome 5 is mounted on top of the reservoir 4 to define a feeding compartment 9 within the dome 5. Access ports 6 on each side of the dome 5 allow through passage of wasps into the feeding compartment 9 to feed at the reservoir 4. An upstanding tower 7 at one side of the base frame 2 supports monitoring and communications equipment indicated generally by the reference numeral 8. The general construction is similar to the wasp feeding station described in my previously filed patent application, publication no. WO 2021/191472 A1 with the exception of the feed reservoir which is described below.

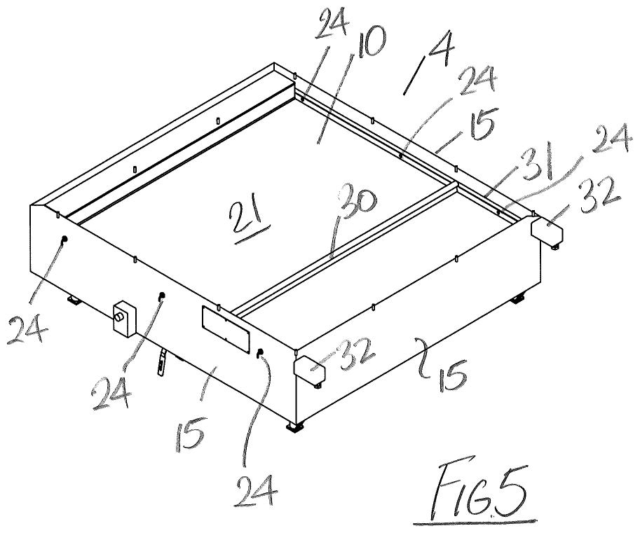

Referring in particular to FIG. 5 to FIG. 9, the feed reservoir 4 is shown in more detail. A solid feed block 10 is mounted on a rigid plate 11 forming a support platform for the block 10 of solid feed. An upwardly open enclosure 12 receives the solid feed block 10. The enclosure 12 has a rectangular base 14 with upstanding side walls 15 extending around a periphery of the base 14. A feeder pump 16 (FIG. 1) periodically operates to pump liquid from the storage tank 3 through a feeder pipe 17 via a pipe reducer 18 into irrigation pipework 19 mounted above the enclosure 12 to deliver a fine liquid mist through spray heads formed by misting valves 20 onto an upper surface 21 of the solid feed block 10. This liquid misting produces a continuous dissolving of the upper surface 21 of the solid feed block 10 into ingestible liquid feed for wasps.

The liquid in the storage tank 3 may conveniently be water, or a water-based liquid with additives such as a scenting agent. The liquid may be heated if required, such as by heaters mounted on or within the storage tank 3.

As a top layer of the solid feed block 10 reduces through ingestion, the solid feed block 10 is automatically lifted to a correct operating height by mechanical levelling arms 22 mounted on the base 14 of the enclosure 12. These mechanical levelling arms 22 are controlled by associated optical levelling sensors 24 mounted on the side walls 15 of the enclosure 12. Mechanical gearing for the levelling arms 22 is mounted within associated housings 26 on a bottom face of the base 14 of the enclosure 12.

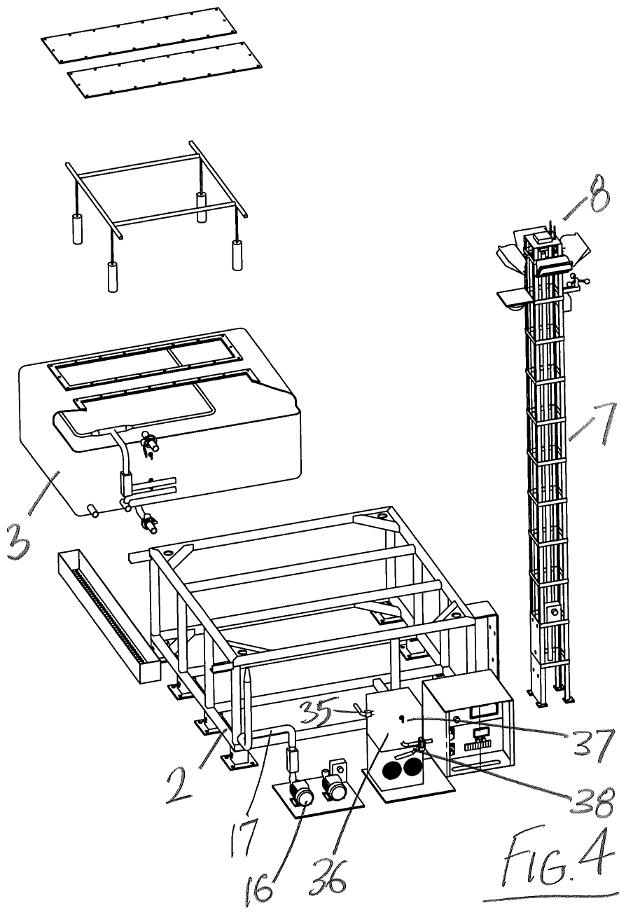

A scraper blade 30 mounted between drive spindles 31 driven by motors 32 is movable back and forth over the upper surface 21 of the solid feed block 10 to maintain a level upper surface 21 on the solid food block 10. A sump drain 33 on the base 14 of the enclosure 12 is connected via pipework 34 to a drainage tank inlet 35 (FIG. 4) on a drainage tank 36. Excess runoff liquids are collected here. The drainage tank 36 has a high level indicator 37 and an outlet 38.

In use, wasps are attracted to consume the feed supply contained within the reservoir 4 beneath the dome 5 and will enter through the access ports 6 to feed at the solid feed block 10. Operation of the misting valves 20 produces a film of liquid feed on the upper surface 21 of the solid feed block 10 from which wasps can consume.

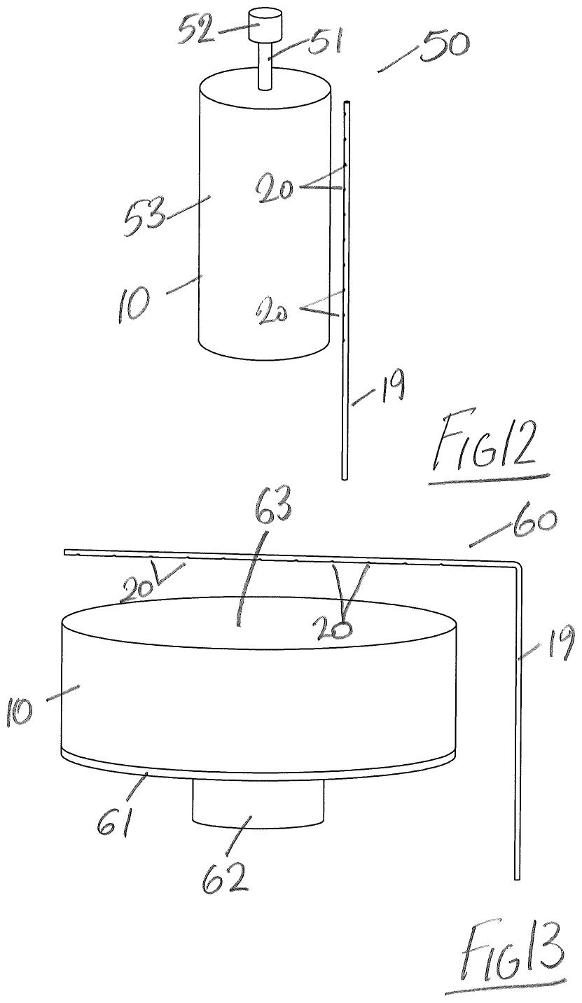

Referring now to FIG. 12, there is shown another solid feed block support for a wasp feeding station according to another embodiment of the invention, indicated generally by the reference numeral 50. Parts similar to those described previously are assigned the same reference numerals. In this case, the solid feed block 10 is in the form of a cylinder mounted on a spindle 51 which is rotatable by means of a motor 52. Misting of liquid is applied vertically through irrigation pipework 19 via misting valves 20 to produce dissolving of the surface 53 of the solid feed block 10 into ingestible liquid feed for wasps.

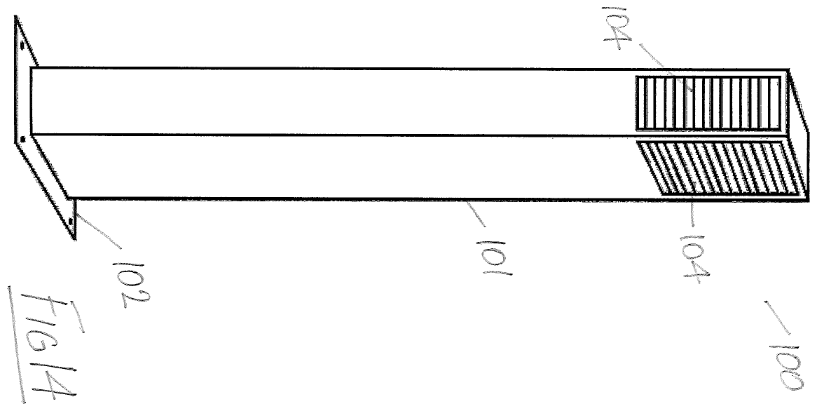

Referring now to FIG. 13, there is shown another solid feed block support for another wasp feeding station according to a further embodiment of the invention, indicated generally by the reference numeral 60. Parts similar to those described previously are assigned the same reference numerals. In this case, a cylindrical solid feed block 10 is mounted on a turntable 61 driven by an associated motor 62. Misting of liquid is applied horizontally through irrigation pipework 19 via misting valves 20 to produce dissolving of an upper surface 63 of the solid feed block 10 into ingestible liquid feed for wasps. Although not shown in the drawing, the turntable 61 may be vertically movable to maintain the upper surface 63 at a desired level as the feed block 10 is consumed.

The invention provides an effective wasp feed and wasp feeding station to control the location of pest activity and pest populations of wasps commonly referred to as Yellow-Jackets, within the Order: Hymenoptera, Family: Vespidae, Genus: Vespula, such as; Common, Eastern, Western, Northern, Southern and Aerial Yellow Jackets, Vespula Germanica, Vespula Vulgaris, Vespula Pensylvanica, Vespula Squamosa, Vespula Maculiforna, Paper wasps and other such pest insects.

The wasp feeding station is a non-kill-non-trap wasp pest control unit and system developed to be active in summer and autumn to resolve the problems and hazards caused during annual wasp infestations. Weatherproof, fully automated, secure and remotely monitored the wasp feeding stations are designed for permanent or seasonal deployment into elevated or on ground-based locations that are isolated from human interaction or intrusion.

The system of the invention provides a controlled relocation of wasps by feeding them, a coordinated network of active wasp feeding stations containing the wasp feed of the invention will produce wasp free areas in urban, rural and agricultural locations of any size or terrain with any scale of hive density or wasp population.

The wasp management system of the invention achieves this method of controlled relocation by supplying wasps with an optimum, target specific, food source. This wasp feed is irresistible to wasps and once discovered, wasps permanently abandon and discard all habitual wasp pest foraging areas and crops in favour of feeding exclusively from these dedicated wasp feeding stations containing the wasp feed of the invention.

In order to maintain a controlled relocation of wasp pest populations by feeding and permanently extracting wasps from feeding at habitual food scavenging areas, ie bins, food vendors, picnic areas, beer gardens etc., it is necessary to provide wasps with a food source that is more desirable than any man made food or naturally occurring fruit food sources.

This target specific wasp food source must also be undesirable and unattractive for ingestion by other pollinators, for example bees, butterflies etc. In order to achieve this in accordance with this invention a traditional bee food recipe is blended with non-toxic, organic and/or synthetic additive bee repellents. The traditional bee food recipe when blended with the additive produces a non-toxic food source which is super attractive to wasps while avoided and disregarded as an edible food source by other pollinators such as bees and butterflies.

In this specification, the terms “comprise, comprise, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described which may be varied in both construction and detail within the scope of the appended claims.

1. A non-toxic wasp feed comprising a honey bee feed in combination with at least one organic and/or synthetic additive that provides the wasp feed with repellent properties and effects to honey bees and insects other than wasps.

2. The wasp feed as claimed in claim 1, wherein the additive comprises a substance which is generally recognised as safe.

3. The wasp feed as claimed in claim 1, wherein the at least one organic and synthetic additive includes one or more of the substances listed in Table 1 herein.

4. The wasp feed as claimed in claim 1, wherein the honey bee feed is produced by dissolving sucrose in water in quantities up to 2200 g of sucrose per 1000 ml of water.

5. The wasp feed as claimed in claim 1, wherein the honey bee feed is high fructose corn syrup or a feed normally consumed by honey bees.

6. The wasp feed as claimed in claim 1, wherein the wasp feed comprises a honey bee feed in an amount in the range 10%-90% by volume or weight and the at least one organic and/or synthetic additive in an amount in the range 90%-10% by volume or weight.

7. The wasp feed as claimed in claim 1, for non-lethal control of wasp pest populations commonly referred to as Yellow-Jackets, within the Order: Hymenoptera, Family: Vespidae, Genus: Vespula, such as; Common, Eastern, Western, Northern, Southern and Aerial Yellow Jackets, Vespula Germanica, Vespula Vulgaris, Vespula Pensylvanica, Vespula Squamosa, Vespula Maculiforna, Paper wasps and other such pest insects.

8. The wasp feed as claimed in claim 1, comprising a blend of traditional honey bee feed syrup with sufficient quantities of the at least one organic and/or synthetic additive that is repugnant and repellent to honey bees, and other non-target pollinators such that the wasp feed is inedible and non-attractive to honey bees and avoided for consumption by butterflies, hoverflies and other non-target pollinators.

9. The wasp feed as claimed in claim 1, comprising a wasp feed formulation of liquid, solid, semisolid, powder or jelly which contains a higher sugar, sucrose or fructose content than foods either produced, consumed or discarded by humans, including agricultural food sources such as the fruits of vineyards, orchards and fruit farms.

10. The wasp feed as claimed in claim 1, comprising a blend of traditional honey bee feed syrup with sufficient quantities of the at least one organic and/or synthetic additive which is generally recognized as safe for use in the food, beverage, cosmetic, wellness, pharmaceutical and other such industries, such as food additives, flavorings, aromas, sweeteners, syrups, enhancers, preservatives, alcohols, aldehydes, ketones, esters, lactones, pyrazines, thiols, essential oils, hydrosols, phenols, natural extracts & isolates.

11. An effective non-trap-non-kill-non-toxic system of wasp pest control by continuously feeding wasps with the wasp feed as claimed in claim 1 to divert wasp pest activity away from humans, foods, beverages, fruit crops, refuse points, buildings, structures and other areas prone to wasp pest infestation without causing harm or stress to the wasp.

12. The system as claimed in claim 11, which includes a weatherproof wasp feeding station, comprising an upstanding column housing to achieve elevation, wasp access ports to a top section of the housing allowing wasps access to and from a wasp feed supply within the housing.

13. The system as claimed in claim 12, wherein the wasp feeding station includes an internal feeding array of food distribution canals and landing surfaces, the feeding array arranged in a vertical, horizontal, angled or a curved configuration, the wasp feeding station adapted for automated processes of feed delivery, feed sanitation, regulated feed temperature, apparatus for dispersion of feed aroma such as vaporization, atomization or evaporation.

14. The system of claim 11, including a wasp feeding station having a support for a block of solid wasp feed, at least one dispensing element for dispensing a mist of liquid droplets against a surface of the solid feed block to dissolve the surface of the solid feed block into a liquid wasp feed.

15. The system as claimed in claim 14, wherein the support comprises a support platform for reception and mounting of the block of solid wasp feed.

16. The system as claimed in claim 15, wherein the support is movable vertically.

17. The system as claimed in claim 14, wherein a level sensor is provided to sense the location of an upper surface of the block of solid wasp feed and positioning means is provided for maintaining the upper surface of the block of solid wasp feed at a desired location.

18. The system as claimed in claim 15, wherein the positioning means comprises one or more levelling elements connected to the support platform for positioning the upper surface of the block of solid wasp feed at the desired location.

19. The system as claimed in claim 14, wherein the support is rotatable.

20-21. (canceled)

22. The system as claimed in claim 12, wherein the wasp feeding station comprises:
a base frame,
a liquid storage tank mounted on the base frame,
a feed reservoir mounted on the base frame for reception and storage of the block of solid wasp feed,
a liquid delivery system for delivering liquid from the liquid storage tank to one or more spray heads for discharge onto the block of solid wasp feed,
a weather protection dome mounted on the base frame above the reservoir to define a feeding compartment within the dome,
at least one access port on the dome to allow through passage of wasps into the feeding compartment to feed at the reservoir.

23. (canceled)
